(19) United States
(12) Patent Application Publication
(10) Pub. No.: US 2007/0169551 A1
(43) Pub. Date: Jul. 26, 2007

(54) MEMS Sensor System with Configurable Signal Module

(75) Inventor: Thomas W. Kelly, North Andover, MA (US)

Correspondence Address: BROMBERG & SUNSTEIN LLP, 125 SUMMER STREET, BOSTON, MA, 02110-1618, US

(73) Assignee: ANALOG DEVICES, INC., Norwood, MA (US)

(21) Appl. No.: 11/553,299

(22) Filed: Oct. 26, 2006

Related U.S. Application Data
(63) Continuation-in-part of application No. 11/150,983, filed on Jun. 13, 2005.

(51) Int. Cl. G01P 15/00; G01P 1/02; G08B 21/00

(52) U.S. Cl. 73/514.01; 73/493; 340/669

(57) ABSTRACT

An apparatus for detecting movement has a signal module for processing a movement signal produced by an inertial sensor, and a configuration module operatively coupled with the signal module. The configuration module configures the signal module to process the movement signal in accord with at least one specified parameter.

### PRIORITY

This patient application is a continuation-in-part of, and claims priority from, U.S. patent application Ser. No. 11/150,983, filed Jun. 13, 2005, entitled, “MEMS SENSOR WITH CONFIGURATION MODULE,” and naming Thomas W. Kelly as inventor, the disclosure of which is incorporated herein, in its entirety, by reference.

### FIELD OF THE INVENTION

The invention generally relates to MEMS devices and, more particularly, the invention relates to configuring MEMS devices.

### BACKGROUND OF THE INVENTION

A variety of different applications use MEMS sensors to detect the motion of an underlying object. For example, MEMS sensors (e.g., accelerometers or gyroscopes), often are mounted about the periphery of the automobile chassis to sense pre-specified accelerations or rotations. The sensors typically cooperate with a central computer that both coordinates their function and responds to pre-specified types of detected motion.

Upon detection of a pre-specified type of motion, the sensors transmit motion data to the computer, which causes systems within the automobile to response in an pre-specified manner. For example, if the sensors detect a sudden and high deceleration, air-bag systems may deploy their air bags. Alternatively, if the sensors detect a sudden rotation (e.g., the automobile is swerving), breaking systems may selectively break to avoid a rollover. Accordingly, sensors have become critical in ensuring automobile safety.

The MEMS sensors often are preconfigured to operate with certain standard parameters. For example, a MEMS sensor may be preconfigured to sense signals having frequencies that are less than or equal to 400 Hertz.

### SUMMARY OF THE INVENTION

In accordance with one aspect of the invention, an apparatus for detecting movement has a signal module for processing a movement signal produced by an inertial sensor, and a configuration module operatively coupled with the signal module. The configuration module configures the signal module to process the movement signal in accord with at least one specified parameter.

In some embodiments, the signal module has a plurality of serially coupled processing modules for processing the movement signal. The specified parameter includes a parameter for at least one of the plurality of processing modules. The plurality of processing modules may include, among other things, a filter and/or an analog to digital converter. In that case, the at least one specified parameter includes the number of poles in the filter, the bandwidth of the filter, and/or the number of bits for output signals from the analog to digital converter. If the above noted plurality of processing modules includes a self-test unit for actuating the inertial sensor, then the at least one specified parameter may include a self-test unit parameter that controls operation of the self-test unit.

The apparatus also may have an interface for receiving the at least one specified parameter from an external device. The configuration module thus may have an input for receiving the at least one specified parameter from the interface. In some embodiments, the at least one specified parameter includes a sensor range parameter, which controls the range of forces from the inertial sensor to be processed by the signal module. Moreover, the apparatus also may have memory operatively coupled with the configuration module. In a corresponding manner, the configuration module has logic for storing the at least one specified parameter in the memory.

In addition to having the noted configuration module and signal module, the apparatus also may include the noted inertial sensor, which can be on a first die. In some embodiments, the configuration module and the signal module are on a second die, which is separate from the first die. In other such embodiments, the inertial sensor, configuration module and signal module are on the same, given die. Some embodiments also have a package forming an interior. The configuration module and signal module may be contained within the interior of the package.

In accordance with another aspect of the invention, a method of configuring a sensor system provides a signal module for processing a movement signal received from an inertial sensor, and a configuration module. The method determines at least one specified parameter for controlling the signal module in its processing of the movement signal, and forwards the at least one specified parameter to the configuration module. The configuration module stores the at least one specified parameter in memory for use by the signal module.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

The foregoing and advantages of the invention will be appreciated more fully from the following further description thereof with reference to the accompanying drawings wherein:

FIG. 1 schematically shows an automobile inertial sensing system that may use an inertial sensor configured in accordance with illustrative embodiments of the invention.

FIG. 2 schematically shows an inertial sensor that may be configured in accordance with illustrative embodiments of the invention.

FIG. 3 schematically shows a block diagram of various functional modules within the sensor shown in FIG. 2.

FIG. 4A schematically shows a block diagram of various functional modules within the configuration module of FIG. 3.

FIG. 4B schematically shows a block diagram of various functional modules within the signal module of FIG. 3.

FIG. 5 shows a process of configuring the sensor shown in FIGS. 2-3 in accordance with illustrative embodiments of the invention.

FIG. 6 shows a illustrative process of initializing the sensor at start up.

### DESCRIPTION OF ILLUSTRATIVE EMBODIMENTS

In illustrative embodiments, a generic MEMS sensor has a local configuration module that configures various components within its internal signal chain. Details of illustrative embodiments are discussed below.

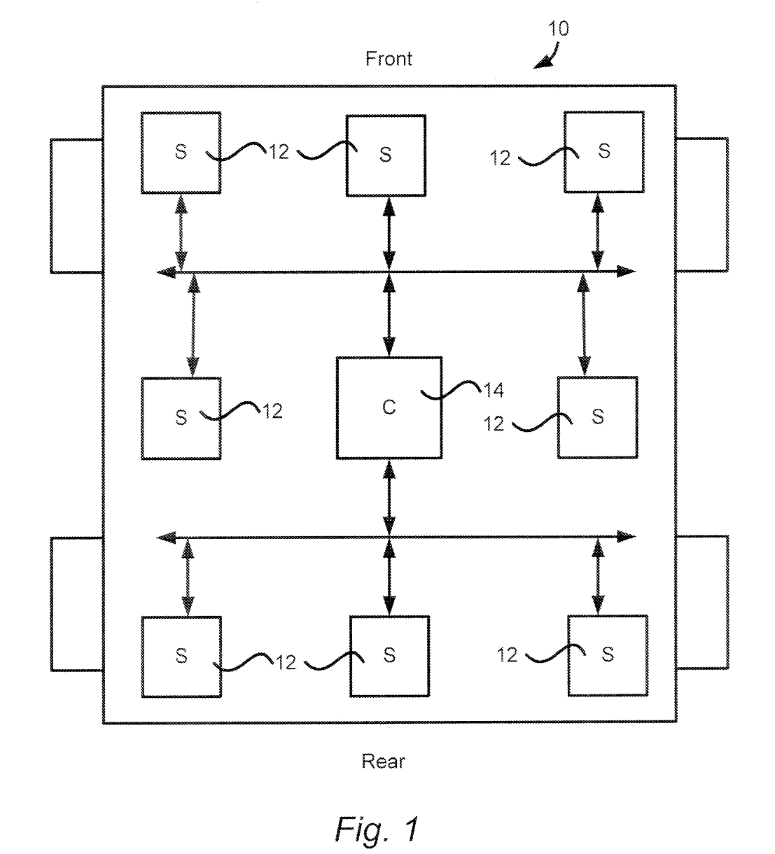

FIG. 1 schematically shows an arrangement that may use sensors implementing illustrative embodiments of the invention. More particularly, the sensing arrangement shown senses movement of an automobile 10. To that end, the sensor arrangement includes a plurality of inertial sensors 12 that communicate with a central computer 14 through some interconnection medium. The sensors 12 may include, among other things, (MEMS) accelerometers for detecting automobile acceleration, and (MEMS) gyroscopes for detecting rotational movement of the automobile 10.

Exemplary MEMS accelerometers are discussed in greater detail in U.S. Pat. No. 5,939,633, which is assigned to Analog Devices, Inc. of Norwood, Mass. Exemplary MEMS gyroscopes are discussed in greater detail in U.S. Pat. No. 6,505,511, which also is assigned to Analog Devices, Inc. of Norwood, Mass. The disclosures of U.S. Pat. Nos. 5,939,633 and 6,505,511 are incorporated herein, in their entireties, by reference.

Although the MEMS sensors 12 are discussed above as inertial sensors, principles of illustrative embodiments can apply to other MEMS devices, such as pressure sensors and microphones. Accordingly, discussion of an inertial sensor is exemplary and not intended to limit the scope of various embodiments of the invention. In a similar manner, it also should be noted that discussion of sensors within an automobile context is for illustrative purposes only. Accordingly, discussion of sensors within this context is not intended to limit the scope of various embodiments of the invention.

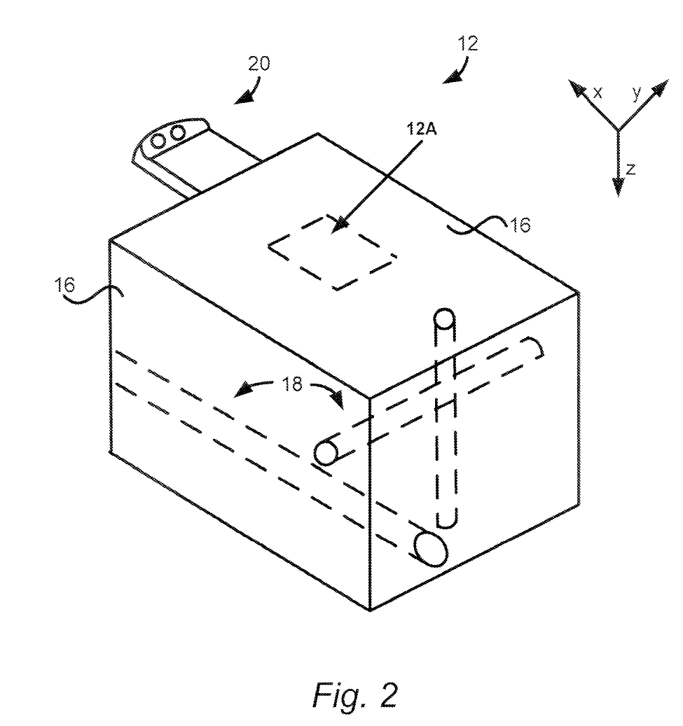

FIG. 2 schematically shows a simplified view of a sensor 12 (referred to as a “satellite sensor 12”) configured in accordance with illustrative embodiments of the invention. Note that FIG. 2 is not necessarily drawn to scale. The satellite sensor 12 has a body 16 containing an inertial sensor device 12A (e.g., a MEMS gyroscope or accelerometer, shown in phantom) and a mounting system 18 for mounting the sensor 12 to a mounting apparatus in an underlying structure (e.g., an automobile chassis). The satellite sensor 12 also has an interface port 20 for communicating with external electronic devices (e.g., the central computer 14 system shown in FIG. 1). The interface port 20 has the mechanical coupling structure for coupling, with a wiring harness, and one or more leads (not shown) to electrically communicate with an external electronic device.

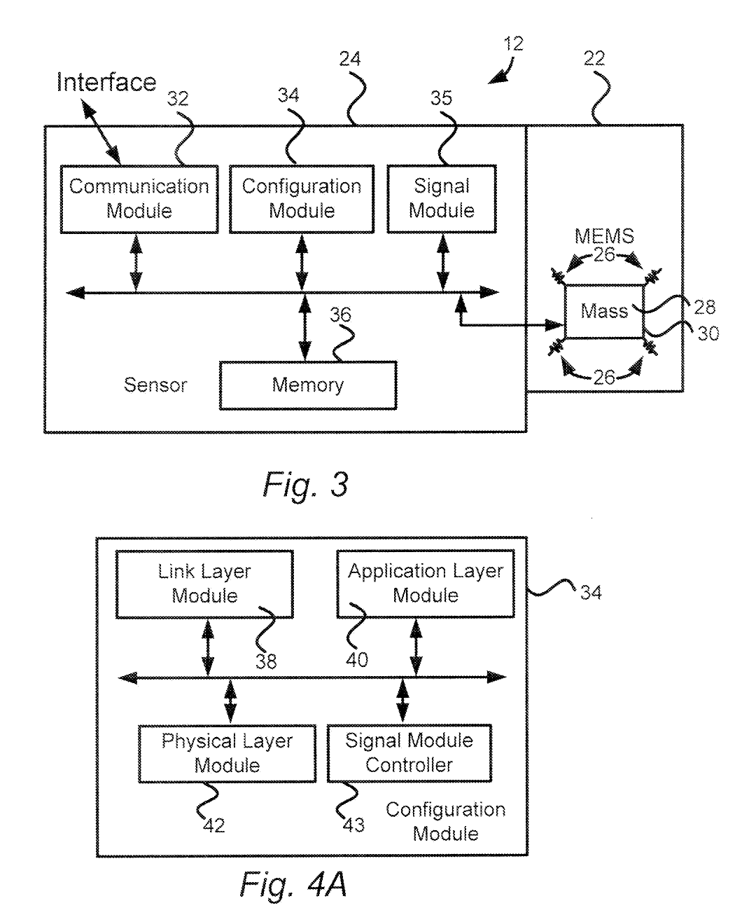

FIG. 3 schematically shows a block diagram of various functional parts of a satellite sensor 12 configured in accordance with illustrative embodiments of the invention. Specifically, the satellite sensor 12 is formed on a single die considered to have a sensor portion 22 and a circuitry portion 24. The sensor portion 22 has a plurality of springs 26 suspending a movable structure 28 (e.g., a mass) from a substrate 30. As known by those skilled in the art, the movable structure 28 moves in a predetermined manner when subjected to an acceleration or rotation. Additional illustrative details of the sensor portion 22 are discussed in the above referenced United States patents.

The circuitry portion 24 has circuitry for 1) detecting and processing movement of the movable structure 28, and 2) interacting with external devices, such as the central computer 14 of FIG. 1. To those ends, among other things, the circuitry portion 24 has:
communication module 32 for communicating with external devices through a local interface,
a configuration module 34 for configuring the communication module 32, and
a signal module 35 for processing movement signals received from the sensing device 12A.

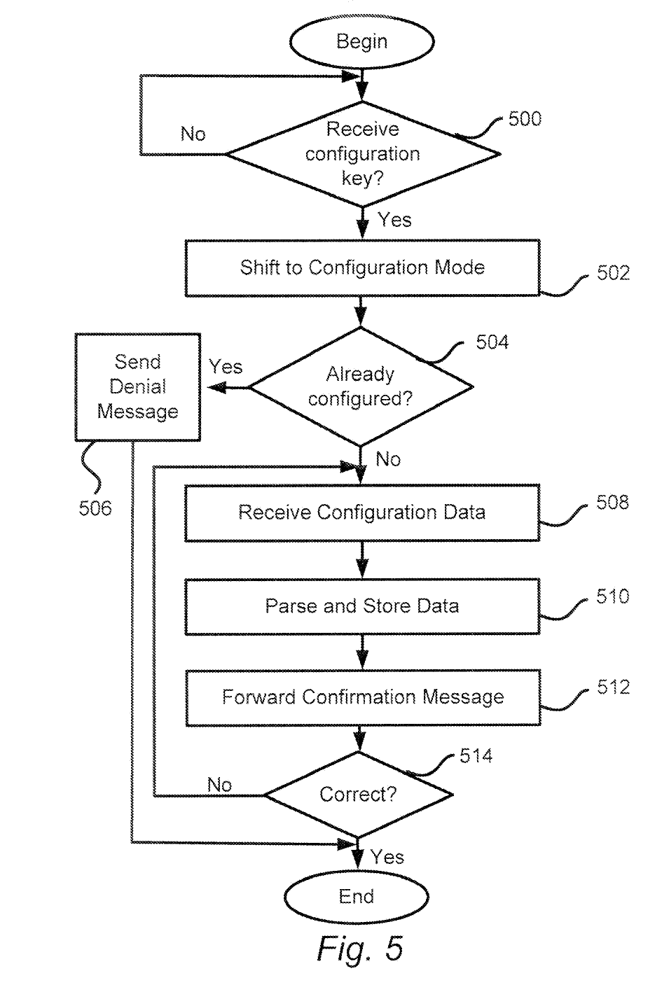

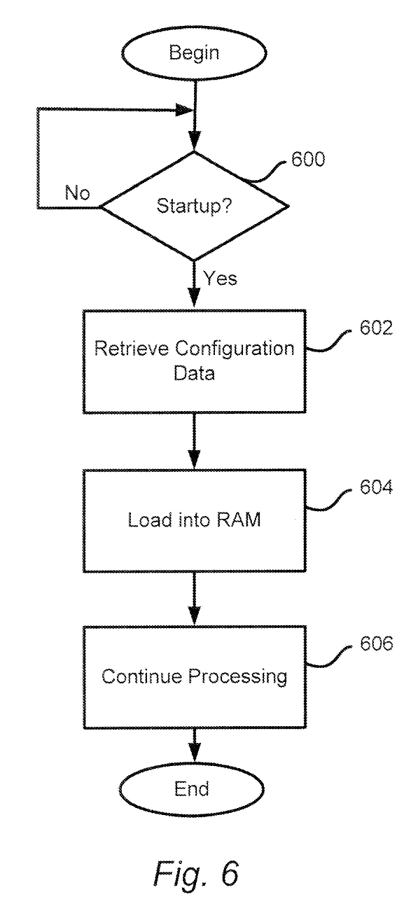

As discussed below and in U.S. patent application Ser. No. 11/150,983, the configuration module 34 enables the end-user to configure operating parameters used by the signal module 35 and/or the communication module 32. The configuration module 34 stores the configuration data in local memory 36. Details of the interaction between the circuitry portion 24 and sensor portion 22 are discussed in greater detail below with regard to FIGS. 5 and 6.

It should be noted that in illustrative embodiments, both the circuitry portion 24 and sensor portion 22 have a number of additional elements not shown in FIG. 3. Details of some of those additional elements are discussed in greater detail in the above incorporated United States patents.

In some embodiments, the satellite sensor 12 may be formed from two separate die, such as a sensor die having no circuitry, and a circuitry die having at least some of the above noted circuitry. Both die illustratively communicate by means of a printed circuit board, wirebonds, or other medium. For example, both die may be secured to an interconnect apparatus within a single package. Discussion of a single die therefore is illustrative and not intended to limit all embodiments of the invention.

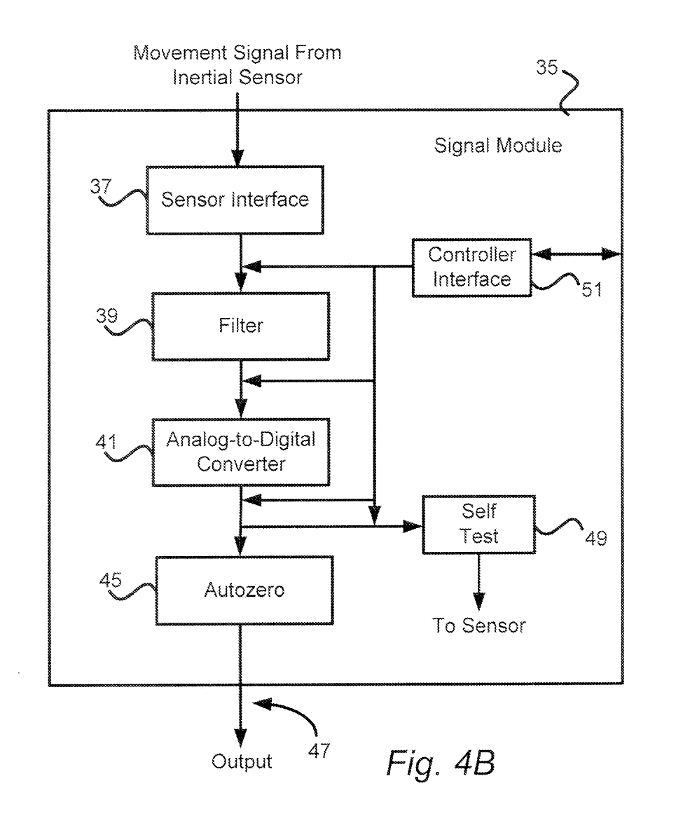

FIG. 4A schematically shows a block diagram of the configuration module 34 shown in FIG. 3. In general, three of the modules shown implement selected functions of the well known seven layer ISO (International Organization for Standardization) protocol stack model. Specifically, as known by those skilled in the art, the noted stack model is an ISO standard for worldwide communications that defines a networking framework for implementing protocols in seven layers. When executing according to the standard, one or more devices pass control from one layer to the next, starting at the application layer in one station. Control proceeds over the channel to the bottom layer, and then back up the hierarchy. Accordingly, among other things, the configuration module 34 includes a link layer module 38 for configuring link layer processes, an application layer module 40 for configuring application layer processes, and a physical layer module 42 for configuring physical layer processes. The configuration module 32 also includes a signal module controller 43 for coordinating configuration of the signal module 35.

FIG. 4B schematically shows a block diagram of various functional modules within the signal module 35 shown in FIG. 3. In general, the signal module 35 has a number of functional blocks that cooperate to process a movement signal, received from the sensor portion 22, for use by an external device (e.g., the computer 14 of FIG. 1). The external device parses this processed signal to determine movement characteristics of the underlying structure (e.g., the automobile 10 of FIG. 1) being measured.

Among other implementations, the signal module 35 can be a single integrated unit having the discussed functionality, a plurality of interconnected, separate functional devices, or a combination thereof. Reference to the single module 35 as a “module” therefore is for convenience and not intended to limit its implementation. Moreover, the various functional devices within the single module 35 can be implemented in any number of ways, such as by means of one or more application specific integrated circuits or digital signal processors. In fact, various modules can be implemented in software.

The signal module 35 thus has a sensor interface 37 for receiving a movement signal from the sensor portion 22, and a filter 39 for filtering the received movement signal. As known by those skilled in the art, the filter 39 determines which part of the input movement signal ultimately is to be used to determine movement information. In illustrative embodiments, the filter 39 is a third order, low-pass Bessel filter.

The signal module 35 also has an analog to digital converter 43 for converting the filtered movement signal into a digital format, and an auto-zero module 45 operatively coupled with an output port 47. As known by those skilled in the art, the auto-zero module 45 generally maintains the output offset voltage at a substantially constant value The signal module 35 optionally may have a self test module 49 that tests the circuitry of prespecified times. For example, after actuating the sensor portion 22 in a prescribed manner, the self test module 49 may analyze the output from at least one point in the signal chain, such as at the output of the analog to digital converter 43, to confirm proper operation.

In accordance with illustrative embodiments of the invention, the signal module 35 also has a controller interface 51 for enabling the configuration module 34 to configure the various described functional modules in the signal chain. More specifically, the signal module controller 43 within the configuration module 34 cooperates with the controller interface 51 (within the signal module 35) to control various of the operating parameters of the functional modules in the signal module 35. For example, the configuration module 34 may forward parameters that control the bandwidth of the filter 39. Details of this interaction are discussed in greater detail below with regard to FIGS. 5 and 6.

FIG. 5 shows a process of configuring the satellite sensor 12 in accordance with illustrative embodiments of the invention. The process begins at step 500, which determines if the sensor 12 has received a configuration key from some external configuring device. More particularly, in illustrative embodiments, the sensor 12 has a pin that can be used for either 1) configuring the communication module 32 or the signal module 35, or 2) transmitting/receiving other data. Accordingly, receipt of the configuration key causes the satellite sensor 12 to enter the “configuration mode” (step 502), consequently indicating that configuration data will be received by that pin. Accordingly, until the configuration mode concludes, the sensor 12 uses all data from that pin to configure the communication module 32 and/or the signal module 35. In illustrative embodiments, the configuration key is a 16-bit word.

Before beginning configuration processes, however, the sensor 12 determines if the communication module 32 already is configured (step 504). To the end, the process may check specified addresses within memory 36 to determine if the sensor 12 is configured. Among other ways, the process may check a single bit that is set to logical “1” after the sensor 12 is configured. If already configured, then the sensor 12 may transmit a denial message to the external configuring device attempting to configure it (step 506). In addition to indicating that the sensor 12 already has been configured, the denial message also may indicate whether the sensor 12 may be reconfigured, thus prompting the external configuring device to transmit configuration data with this understanding. In illustrative embodiments, however, receipt of the denial message ends the process.

If the sensor 12 has not already been configured, however, then the process continues to step 508, in which the sensor 12 receives configuration data from the external configuring device. Among other things, such configuration data may comprise one or more of link layer, application layer, and physical layer data. That and other configuration data may be used to configure one or both of the communication module 32 and the signal module 35. The appropriate module within the configuration module 34 processes its respectively received configuration data. For example, the signal module controller 43 may store received signal module parameters at an appropriate memory location for subsequent use by the signal module 35. Among other things, the configuration data may include any of the following:

Physical Layer (ISO layer 1)
Manchester data encoding information, including phase data, and
synchronization pulse enable/disable

Data Link Layer (ISO layer 2)
data width (e.g., 8 or 10 bit data),
descriptor field: enable/disable, and
error detection: parity or CRC.

Application Layer (ISO layer 7)
serial number and configuration data transmission mode and
self tests: (e.g., internal self tests pass/fail discrimination or external self test data evaluation).

Other and related configuration data may include, among other things, auto-zero on/off controls, self-test parameters (e.g., simulated acceleration values to be applied to the mass 28), width of the data word produced by the analog-to-digital converter 43, frequency/frequencies of the filter 39 and bandwidth, number of poles of the filter 39, a sensor range parameter controlling the range of forces from the sensor portion 22 to be processed by the signal module 35. For example, the “g” force range can be configured to sense a prespecified maximum force, such as between plus or minus 50 g and plus or minus 500 g. In a manner similar to other aspects of the invention, this list is meant to be illustrative and thus, various embodiments should not be limited to the parameters in this list.

The process thus continues to step 510, in which the appropriate module(s) parse and store the received configuration data. More particularly, illustrative embodiments receive the configuration data in any one of the number of different types of data frames. For example, the frames may have, among other things, data bits with the configuration data, address bits identifying the address in memory 36 for storing the configuration data, read/write command bits indicating whether the operation is a read or write operation, and a parity bit for error checking.

The configuration module 34 illustratively stores the configuration data in one time programmable read-only memory (ROM). Other embodiments, however, may use other types of volatile or nonvolatile memory. By way of example, in illustrative embodiments, the one time programmable read-only memory may be comprised by three 8-bit registers respectively identified as REG0, REG1, and REG2. Table 1 below shows exemplary data that may be stored within specific bits of those registers

TABLE 1

| Register | Bit 7 | | | | | | | Bit 0 |
|---|---|---|---|---|---|---|---|---|
| Name | (MSB) | Bit 6 | Bit 5 | Bit 4 | Bit 3 | Bit 2 | Bit 1 | (LSB) |
| REG0 | UD | UD | MD1 | MD0 | FDLY | DLY2 | DLY1 | DLY0 |
| REG1 | STI | AZE | SYEN | ADME | ERC | SVD | DAT | MAN |
| REG2 | CUPRG | CUPAR | SCOE | FC1 | FC0 | RG2 | RG1 | RGO |

The codes within Table 1 identified as shown in Table 2 below;

TABLE 2

| CODE | DEFINITION |
|---|---|
| UD | User Data |
| MD1 | Phase 2 mode select 1 |
| MD0 | Phase 2 Mode Select 0 |
| FDLY | Data transmission delay |
| DLY2 | Data transmission delay |
| | select bit 2 |
| DLY1 | Data transmission delay |
| | select bit 1 |
| DLY0 | Data transmission delay |
| | select bit 0 |
| STI | External self test |
| AZE | Auto zero enable |
| SYEN | Sync pulse enable |
| ADME | Auto delay mode |
| | disabled |
| ERC | Parity/CRC select |
| SVD | State vector transmission |
| | enabled |
| DAT | 8/10-bit data |
| MAN | Manchester data |
| | encoding select |
| CUPRG | Configuration register |
| | program bit |
| CUPAR | Configuration register |
| | parity bit |
| SCOE | Signal chain output |
| | enable |
| FC1 | Bessel filter bandwidth |
| | select 1 |
| FC0 | Bessel filter bandwidth |
| | select 0 |
| RG2 | Sensor range select 2 |
| RG1 | Sensor range select 1 |
| RG0 | Sensor range select 0 |

The process then continues to step 512, which forwards a confirmation message to the external configuring device. Specifically the configuration module 34 transmits a message indicating that configuration has been completed. In some embodiments, however, a confirmation message also may include data indicating whether the configuration process has successfully completed. For example, if the configuration module 34 detects a parity error, it may transmit a confirmation message having data indicating the error. The external configuring device responsively may reinitiate the entire configuration process.

Some embodiments forward configuration data back to the external configuring device as a data integrity check. For example, the configuration module 34 may load the configuration data into random access memory (RAM) from the read-only memory. Next, the configuration module 34 may read the configuration data from the random access memory for transmission to the external configuring device via the confirmation message.

Upon receipt of the confirmation message, the external configuring device may check the received configuration data to confirm its accuracy (step 514). If not accurate, the process loop back to step 508, in which the configuration module 34 again receives the configuration data. Conversely, the process ends if the data is determined to be accurate at step 514.

In contrast to the communication between the communication module 32 and other external devices, the configuration module 34 communicates with the external configuring device (i.e., the device transmitting the configuration data) by means of a fixed communication protocol. In face, the configuration module 34 may use the communication module 32 to communicate with the external configuring device. Alternatively, the configuration module 34 could use a separate communication means, such as one of many well known serial or parallel communication standards. Some embodiments, however, permit this fixed protocol to also be changed in a manner similar to that discussed above.

In anticipated implementations, the end-user may be provided with a set of options for configuring the communication module 32 and the signal module 35. Such options may be provided in any number of formats, including an interactive configuration program and/or a specification sheet. As one example, the end-user may be provided with a menu of several different word length formats that the sensor 12 can use. As a second example, the end-user may be provided with several different sets of proprietary configuration protocol data used by various sensor vendors. For example, one set may include the communication protocol data for a sensor distributed by Analog Devices, Inc., while another set may include the communication protocol data for a sensor distributed by another sensor distributor. As a further example, the end-user may be provided with a set of different bandwidths for the filter 39.

After the configuration module 34 configures the communication protocol of the communication module 32 (e.g., by the process of FIG. 5), the sensor 12 can complete other initial processes and/or operate in its intended environment. FIG. 6 shows illustrative initialization process that the sensor 12 may use to retrieve the stored configuration data. The process begins in step 600, which determines that the sensor 12 is in a startup mode. The sensor 12 then retrieves the configuration data from the one time programmable read-only memory (step 602) for storage in random access memory (step 604). Alternatively, the configuration data could remain in the one time programmable read-only memory. At this point, the sensor 12 may continue processing, which involves communicating with external devices (step 606).

Accordingly, illustrative embodiments have the versatility to enable an end-user to configure the sensor 12 to communicate with external devices by means of any one of a variety of different communication protocols. In a similar manner, illustrative embodiments also able the in user to configure the signal module 35.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible medium, such as a computer readable medium (e.g., diskette, CD-ROM, ROM, or fixed disk) or transmittable to a computer system, via a modem or other interface device, such as a communications adapter connected to a network over a medium. The medium may be either a tangible medium (e.g., optical or analog communication lines) or a medium implemented with wireless techniques (e.g., WIFI, microwave, infrared or other transmission techniques). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

Although the above discussion discloses various exemplary embodiments of the invention, it should be apparent that those skilled in the art can make various modifications that will achieve some of the advantages of the invention without departing form the true scope of the invention.

What is claimed is:

1. An apparatus for detecting movement, the apparatus comprising:
a signal module for processing a movement signal produced by an inertial sensor; and
a configuration module operatively coupled with the signal module, the configuration module configuring the signal module to process the movement signal in accord with at least one specified parameter.

2. The apparatus as defined by claim 1 wherein the signal module comprises a plurality of serially coupled processing modules for processing the movement signal, the specified parameter including a parameter for at least one of the plurality of processing modules.

3. The apparatus as defined by claim 2 wherein the plurality of processing modules includes at least one of a filter and an analog to digital converter.

4. The apparatus as defined by claim 3 wherein the at least one specified parameter includes at least one of the number of poles in the filter, the bandwidth of the filter, and the number of bits for output signals from the analog to digital converter.

5. The apparatus as defined by claim 2 wherein the plurality of processing modules includes a self-test module for actuating the inertial sensor, the at least one specified parameter including a self-test unit parameter that controls operation of the self-test unit.

6. The apparatus as defined by claim 1 further comprising an interface for receiving the at least one specified parameter from an external device, the configuration module having an input for receiving the at least one specified parameter from the interface.

7. The apparatus as defined by claim 1 wherein the at least one specified parameter includes a sensor range parameter, the sensor range parameter controlling the range of forces from the inertial sensor to be processed by the signal module.

8. The apparatus as defined by claim 1 further comprising memory operatively coupled with the configuration module, the configuration module having logic for storing the at least one specified parameter in the memory.

9. The apparatus as defined by claim 1 further comprising the inertial sensor on a first die, the configuration module and the signal module being on a second die, the first die being separate from the second die.

10. The apparatus as defined by claim 1 further comprising the inertial sensor on a given die, the configuration module and the signal module also being on the given die.

11. The apparatus as defined by claim 1 further comprising the inertial sensor.

12. The apparatus as defined by claim 1 further comprising a package having an interior, the configuration module and signal module being contained within the interior of the package.

13. A method of configuring a sensor system, the method comprising:
providing a signal module for processing a movement signal received from an inertial sensor;
providing a configuration module;
determining at least one specified parameter for controlling the signal module in its processing of the movement signal;
forwarding the at least one specified parameter to the configuration module, the configuration module storing the at least one specified parameter in memory for use by the signal module.

14. The method as defined by claim 13 wherein the signal module comprises a plurality of serially coupled processing modules for processing the movement signal, the specified parameter including a parameter for at least one of the plurality of processing modules.

15. A motion detector comprising:
an inertial sensor for sensing movement, the inertial sensor producing a movement signal that is a function of movement;
a signal module for processing the movement signal; and
means for configuring the signal module to process the movement signal in accord with at least one specified parameter.

16. The motion detector as defined by claim 15 wherein the signal module comprises a plurality of serially coupled processing modules for processing the movement signal, the specified parameter including a parameter for at least one of the plurality of processing modules.

17. The motion detector as defined by claim 16 wherein the plurality of processing modules includes at least one of a means for filtering the movement signal and means for converting an analog signal to a digital signal.

18. The motion detector as defined by claim 17 wherein the at least one specified parameter includes at least one of the number of poles in the filtering means, the bandwidth of the filtering means, and the number of bits for output signals from the converting means.

19. The motion detector as defined by claim 15 wherein the inertial sensor is on a first die, the signal module and configuration means being on a second die, the first die being separate from the second die.

20. The motion detector as defined by claim 15 wherein the inertial sensor, signal module, and configuration means are within a single package.
